(19) United States
(12) Patent Application Publication
(10) Pub. No.: US 2012/0148096 A1
(43) Pub. Date: Jun. 14, 2012

(54) APPARATUS AND METHOD FOR CONTROLLING IMAGE USING MOBILE PROJECTOR

(75) Inventors: Gyu-Bong LEE, Suwon-si (KR); Yong-Chan KEH, Gangnam-gu (KR)

(73) Assignee: Samsung Electronics Co., Ltd., Suwon-si (KR)

(21) Appl. No.: 13/314,569

(22) Filed: Dec. 8, 2011

(30) Foreign Application Priority Data
Dec. 8, 2010 (KR) 10-2010-0124923

(51) Int. Cl. G06K 9/00; G09G 5/00

(52) U.S. Cl. 382/103; 345/156

(57) ABSTRACT

Disclosed is an image control system using a mobile projector, including a first apparatus configured to determine, when a first picture is projected and a user input for a specific image is received, whether the projected first picture is projected onto the specific image, and if so, control the specific image to perform an operation corresponding to the user input, and a second apparatus configured to, receive the user input from the first apparatus, determine whether the first picture is projected onto the specific image, and if so, perform an operation corresponding to the user input.

### PRIORITY

This application claims priority under 35 U.S.C. §119(a) to an application entitled “Apparatus and Method for Controlling Image Using Mobile Projector” filed in the Korean Industrial Property Office on Dec. 8, 2010 and assigned Serial No. 10-2010-0124923, the content of which are incorporated herein by reference.

### BACKGROUND OF THE INVENTION

1. Field of the Invention

The present invention relates generally to a mobile projector, and more particularly to an apparatus and a method for sharing, transmitting, and controlling an image of a mobile terminal by using a mobile projector mounted to the mobile terminal.

2. Description of the Related Art

Display apparatuses generally refer to apparatuses such as a monitor for displaying information such as letters, graphs, or figures on various electronic devices. Among the devices, a projector refers to a projection type display device, and is connected to an electronic device such as a computer to enlarge and project a picture displayed on a display unit of the connected electronic device on a screen through an optical lens.

The projector projects a specific picture on a screen through a lens unit including a focus lens for adjusting the focus. When a position of the projector or the screen is varied, the projector re-adjusts the focus using the focus lens for an exact focus.

In this instance, when the focus of the focus lens is re-adjusted, a method of moving a focus forward and rearward by manually turning the focus lens and a method of moving the focus lens by pushing a button and rotating a focus lens feeding motor are generally used.

Although such a projector is expensive and has been primarily used, for example, in public events such as conferences, projectors for home use have recently become popular. Moreover, along with development of mobile terminals such as mobile phones, manufacturers are producing highly portable mobile projectors that are small enough to be mounted to mobile terminals.

FIG. 1 illustrates a conventional mobile terminal including a mobile projector. The projector of FIG. 1 includes a projector module 101, an input unit 103, a control unit 105, an output unit 107, and a storage unit 109.

The projector module 101 serves to project an image signal to a projection surface such as a screen, and is equipped with a focus lens (not shown) for adjusting a focus of an image projected to the projection surface. The input unit 103 serves to receive various inputs from a user, and input reception may be identified by a touch of a touch screen or a button press. If an input is received from a user through the input unit 103, the control unit 105 serves to perform a control operation for projecting a specific image to the projection surface through the projector module 101.

The output unit 107 is a screen such as a Liquid Crystal Display (LCD) panel of a mobile terminal, and an image projected through the projector module 101 is output as it appears. The storage unit 109 stores various data containing a specific image, and provides a specific image when a request for the specific image is received from the control unit 105.

Since a size of an image projected to the projection surface by the mobile projector can be increased, a desired image can be viewed with other persons. However, an output image can be controlled only through the mobile terminal to which the mobile projector is mounted, and it is not possible to control an image projected by a mobile terminal to which another mobile projector is mounted, through the mobile terminal to which its own mobile projector is mounted.

### SUMMARY OF THE INVENTION

Accordingly, an aspect of the present invention is to solve the above-stated problems occurring in the prior art, and to provide a method of allowing two or more mobile projectors to share information such as their locations, clicks, touches, and projected contents while controlling each other, or transmitting and receiving desired data while viewing an image projected through the mobile projectors.

In accordance with an aspect of the present invention, there is provided an image control apparatus using a mobile projector, the image control apparatus including a projector module configured to project a first picture to a projection surface, a wireless network module configured to perform a communication with a counterpart apparatus projecting a second picture, and a control unit configured to determine, when a user input for a specific image included in the second picture projected by the counterpart apparatus is received, whether the projected first picture is projected onto the specific image included in the second picture, and when the first picture is projected onto the specific image, control the counterpart apparatus to perform an operation corresponding to the user input by the specific image.

In accordance with another aspect of the present invention, there is provided a method for controlling an image using a mobile projector, the method including establishing a communication connection with a counterpart apparatus projecting a second picture, projecting a first picture onto a projection surface, receiving a user input for a specific image included in the second picture projected by the counterpart apparatus, determining whether the first picture is projected onto a specific image included in the second picture, and controlling, when the first screen is projected onto the specific image, the counterpart apparatus to perform an operation corresponding to the user input by the specific image.

In accordance with another aspect of the present invention, there is provided an image control system using a mobile projector, including a first apparatus configured to determine, when a first picture is projected and a user input for a specific image is received, whether the projected first picture is projected onto the specific image, and if the first picture is projected onto the specific image, control the specific image to perform an operation corresponding to the user input, and a second apparatus configured to receive, when the specific image is projected, the user input from the first apparatus, determine whether the first picture is projected onto the specific image, and if the first picture is projected onto the specific photo image, perform an operation corresponding to the user input.

### BRIEF DESCRIPTION OF THE DRAWINGS

The above and other aspects, features and advantages of the present invention will be more apparent from the following detailed description taken in conjunction with the accompanying drawing, in which:

FIG. 1 illustrates a conventional projector capable of adjusting a focus;

FIG. 2 illustrates a mobile terminal for controlling an image using a mobile projector according to an embodiment of the present invention;

FIG. 3 illustrates projections of mobile terminals including the mobile projector according to the embodiment of the present invention;

FIG. 4 illustrates a process of enlarging a specific image using the mobile projector according to the embodiment of the present invention;

FIG. 5 illustrates a process of copying a specific image using the mobile projector according to the embodiment of the present invention;

FIG. 6 illustrates a process of recognizing a location using the mobile projector according to the embodiment of the present invention; and

FIG. 7 illustrates a process of controlling an image using the mobile projector according to the embodiment of the present invention.

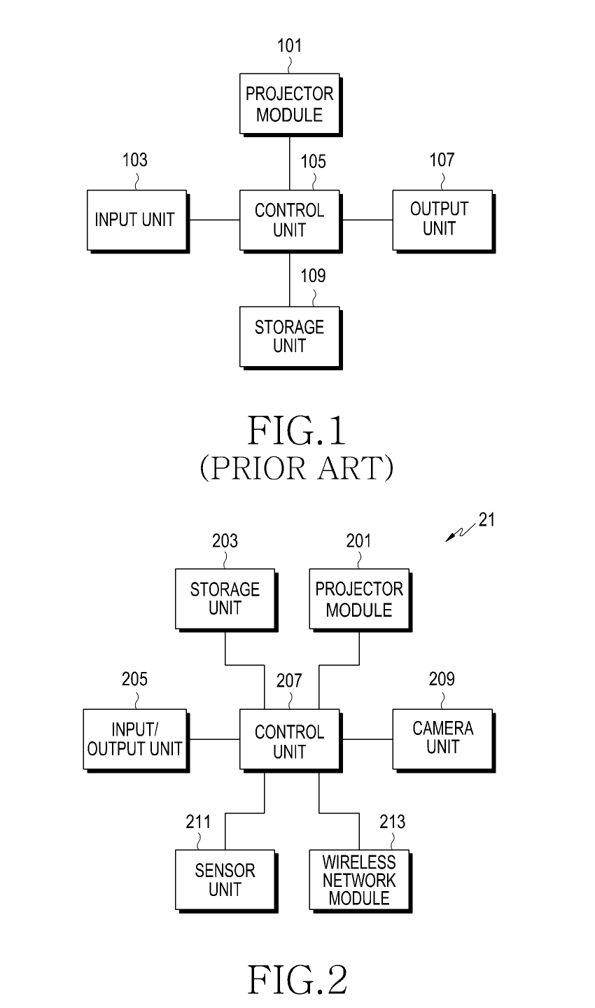

### DETAILED DESCRIPTION OF EMBODIMENTS OF THE PRESENT INVENTION

Hereinafter, embodiments of the present invention will be described with reference to the accompanying drawings. Various specific items found in the following description, such as specific elements, are provided only to help general understanding of the present invention, and it is apparent to those skilled in the art that those specific items may be changed or modified without departing from the scope of the present invention. Detailed descriptions of constructions or processes known in the art may be omitted for the sake of clarity and conciseness.

FIG. 2 illustrates a mobile terminal for controlling an image using a mobile projector according to an embodiment of the present invention. The mobile terminal 21 of FIG. 2 includes a projector module 201, a storage unit 203, an input/output unit 205, a control unit 207, a camera unit 209, a sensor unit 211, a wireless network module 213.

Referring to FIG. 2, the projector module 201 serves to project a specific image stored in the storage unit 203 to a projection surface under the control of the control unit 207. The input/output unit 205 serves to receive a user input and output a specific image on a screen such as a touch screen or an LCD panel. The input/output unit 205 may include a touch screen, or a keypad and a separate screen. The storage unit 203 stores a plurality of images, and serves to transfer a specific image to the input/output unit 205 or the projector module 201 under the control of the control unit 207.

The camera unit 209 serves to recognize an image projected from the projector module 201 and an image projected from a projector module of another mobile terminal, and to transfer the recognized image to the controller 207. The sensor unit 211 serves to recognize a movement of the mobile terminal 21 and transfer a resulting value on the movement of the mobile terminal 21 to the control unit 207. The wireless network module 213 serves to establish a wireless communication connection with another mobile terminal.

The control unit 207 serves to perform a control operation for projecting a specific image through the projector module 201, performs a control operation for recognizing an image projected from the projector module of the other mobile terminal through the cameral module 209 when a communication connection with the other mobile terminal is established, and performs a control operation for transmitting information on a received demand input to the other mobile terminal if a user demand input on the image projected from the projector module of the other mobile terminal is received.

For example, when a cursor shaped image is projected to the projector module 201 of the mobile terminal 21 and an arbitrary image is projected to a projector of another mobile terminal in communication with the mobile terminal 21, when a user desires to perform a control operation for enlarging, copying, and deleting the arbitrary image, the mobile terminal 21 is moved to allow the cursor shaped image to be projected onto the projected arbitrary image. When the input/output unit 205 is touched, dragged, or clicked, the projected arbitrary image is controlled through the projector module of the other mobile terminal. The mobile terminal 21 may perform the above operation when it is moved to project an empty picture instead of the cursor shaped image and project a specific region of the empty picture onto the arbitrary image.

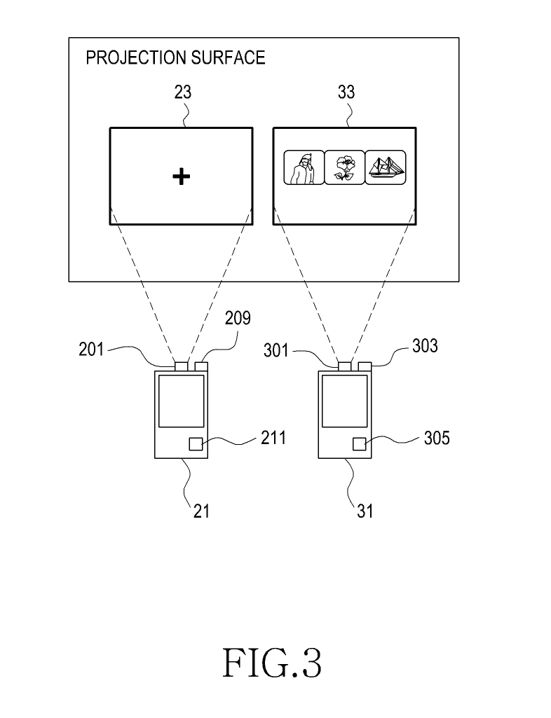

FIG. 3 illustrates projections of mobile terminals including the mobile projector according to the embodiment of the present invention.

Referring to FIG. 3, the mobile terminal 21, which includes a projector module 201, a camera unit 209 and a sensor unit 211, projects a first picture 23 output on the output unit of the mobile terminal 21 using the projector module 201. Although a cursor shaped image is included in the projected picture in the drawing, an empty picture may be projected to a projection surface. The counterpart mobile terminal 31, which includes a projector module 301, a camera unit 303 and a sensor unit 305, is in communication with the mobile terminal 21 and projects a second picture 33 output on an output unit of the counterpart mobile terminal 31 using a projector module 301. It is assumed that a photo image is projected to the projection surface of the counterpart mobile terminal 31. The mobile terminal 21 and the counterpart mobile terminal 31 may recognize both the two pictures 23 and 33 projected through the camera units 209 and 303. Since angles of view of the camera units 209 and 303 are much larger than angles of view of the projector modules 201 and 301, the two projected pictures 23 and 33 may be sufficiently recognized only when a distance between the two pictures 23 and 33 deviates from the angles of view of the camera units 209 and 303. In other words, when the distance between the two pictures 23 and 33 is in the angles of view of the camera units 209 and 303, the mobile terminal 21 recognizes the two projected pictures 23 and 33.

When communication connection between the mobile terminal 21 and the counterpart mobile terminal 31 is established, the mobile terminal 21 controls the image included in the second picture 33 projected through the counterpart mobile terminal 21 while exchanging a touch on a touch screen, a button input, a movement result value through the sensor unit 211 and 305 with the counterpart mobile terminal 31.

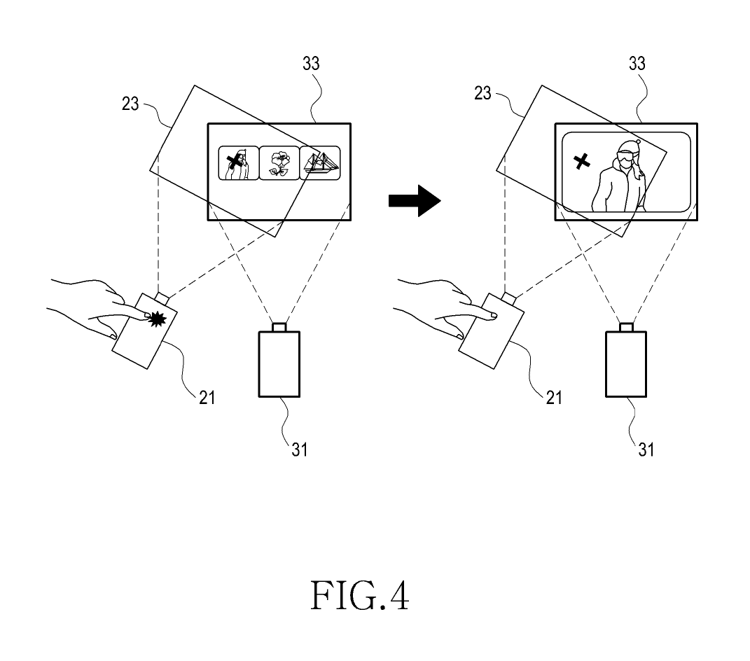

FIG. 4 illustrates a process of enlarging a specific image using the mobile projector according to the embodiment of the present invention. In FIG. 4, it is assumed that the mobile terminal 21 and the counterpart mobile terminal 31 are in communication with each other.

Referring to FIG. 4, the projector module 301 of the counterpart mobile terminal 31 projects the second picture 33 having three images onto the projection surface, and the first picture 23 projected by the projector module 209 of the mobile terminal 21 is projected onto the second picture 33. The first picture 23 may include the cursor image as in FIG. 4, and may be projected as an empty picture. If a user of the mobile terminal 21 desires to enlarge the first one of the three images included in the second picture 33, the mobile terminal 21 is moved so that the cursor image in the first picture 23 is projected to the first one of the three images in the second picture 33, and the input/output unit 205 of the mobile terminal 21 is touched or clicked.

When the first picture 23 projected is an empty picture, the above process is performed after a user sets a specific region of the first picture 23 to a region corresponding to the cursor image. For example, when a user sets a central region of the first picture 23 to a region corresponding to the cursor image, the mobile terminal 21 is moved such that the central region of the first picture 23 is projected onto the first one of the three images in the second picture 33.

If an input is received through the input/output unit 205, the mobile terminal 21 transmits a request message for enlarging the first image included in the second picture 33 to the counterpart mobile terminal 31 and the counterpart mobile terminal 31 recognizes whether the cursor image or the specific region included in the first picture 23 is projected onto any one of the three image included in the second picture 33. When the counterpart mobile terminal 31 recognizes that the cursor image or the specific region is projected onto the first image, such information is transferred to the counterpart mobile terminal 31 and the counterpart mobile terminal 31 enlarges and projects only the first one of the three images included in the second picture 33.

When the first picture 23 is an empty picture and a central region is set to a region corresponding to the cursor image, and the central region of the first picture 23 has been properly projected onto the first one of the three images included in the second picture 33, a separate output such as a flickering of a Light Emitting Diode (LED) or a beep sound may be generated to inform a user of this instance.

Although FIG. 4 illustrates the enlarging of the first image of the second picture 33, a specific image may be reduced or deleted depending on the number of times of touches or clicks on the input/output unit 205, and such input information may be exchanged during a communication between the initial mobile terminations.

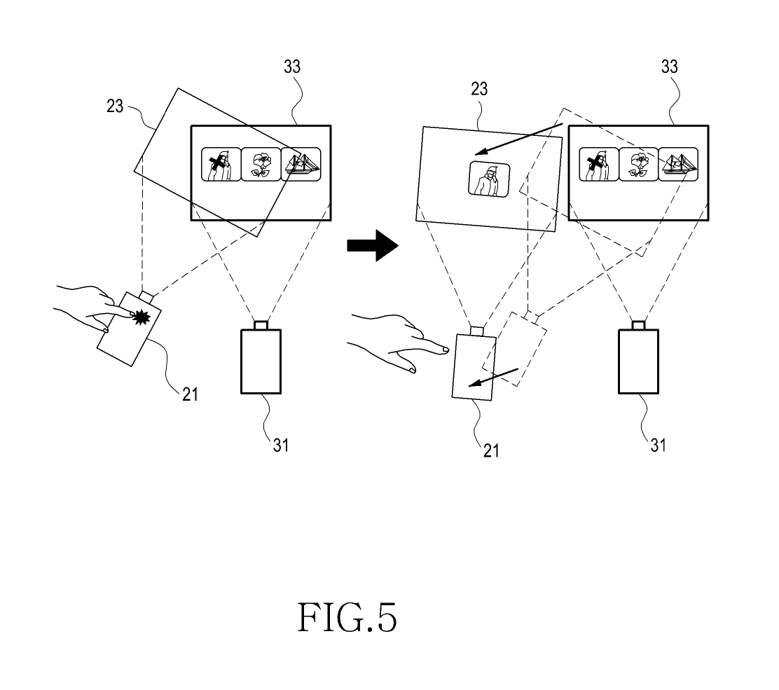

FIG. 5 illustrates a process of copying a specific image using the mobile projector according to the embodiment of the present invention. In FIG. 5, it is assumed that the mobile terminal 21 and the counterpart mobile terminal 31 are in communication with each other.

Referring to FIG. 5, the projector module 301 of the counterpart mobile terminal 31 projects the second picture 33 having three images onto a projection surface and the first picture 23 projected by the projector module 209 of the mobile terminal 21 is projected onto the second picture 33. The first picture 23 of FIG. 5 may also include a cursor image and may be projected as an empty picture.

When a user of the mobile terminal 21 desires to copy the first one of the three images included in the projected second picture 33 to the mobile terminal 21 and project the first image into the first picture 23, the mobile terminal 21 is moved such that the cursor image in the first picture 23 is projected onto the first one of the three images in the second picture 33, and then is moved in an arbitrary direction until the first picture 23 does not overlap the second picture 33 with the input/output unit 205 of the mobile terminal 21 being touched or clicked.

When the first picture 23 is an empty picture, the above process is performed after a user sets a specific region of the first picture 23 to a region corresponding to the cursor image. For example, when a user sets a central region of the first picture 23 to a region corresponding to the cursor image, the mobile terminal 21 is moved such that the central region of the first picture 23 is projected onto the first one of the three images included in the second picture 33. Then, the mobile terminal 21 is moved in an arbitrary direction until the first picture 23 does not overlap the second picture 33 with the input/output unit 205 of the mobile terminal 21 being touched or clicked.

If the control unit 207 of the mobile terminal 21 detects that the mobile terminal 21 is moving through the sensor unit 211 while the mobile terminal 21 is continuously touched or clicked through the input/output unit 205, a request message for copying the first image is controlled to be transmitted to the counterpart mobile terminal 31, which having received the request message recognizes that the cursor image or the specific region of the first picture 23 is projected onto any one of the three images included in the second picture 33 using the camera unit 303.

If it is confirmed that the cursor image or the specific region of the first picture 23 is located on the first image of the second picture 33 and the first picture 23 is moved to a range where the first picture 23 does not overlap the second picture 33, the counterpart mobile terminal 31 copies data regarding the first one of the three images included in the second picture 33 and transmits the data to the mobile terminal 21. When receiving the data regarding the first image from the counterpart mobile terminal 31, the mobile terminal 21 may project the first image onto the first picture 23 and inform a user that the first image is completely copied.

The series of processes may be easily understood through the projected pictures. If the input/output unit 205 of the mobile terminal 21 is touched or clicked, input information can be identified through a color change or a size change of the cursor image, as well as the process of moving the mobile terminal 21 with the input/output unit 205 of the mobile terminal 21 being touched or clicked. Thus, a user of the mobile terminal 21 can easily identify the steps to perform through the projected picture.

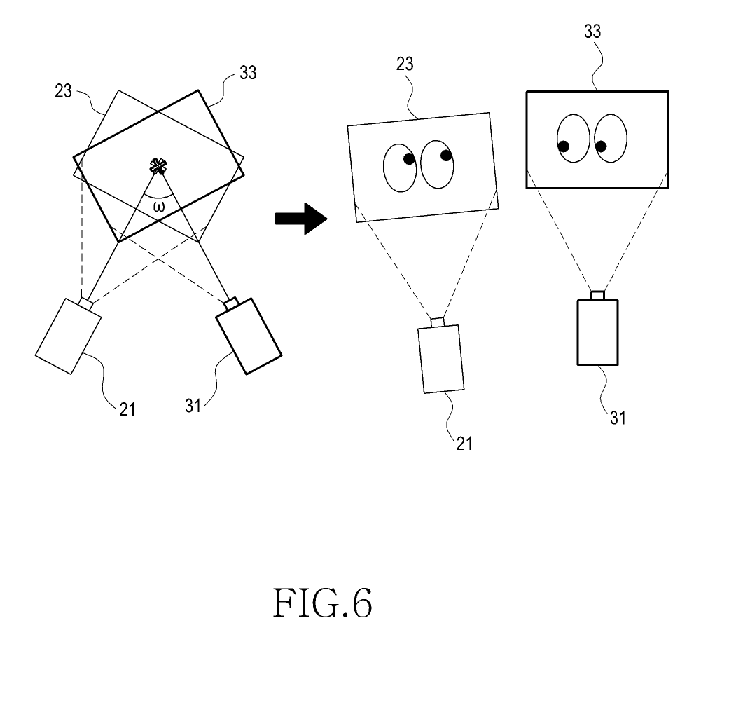

Meanwhile, although the cursor image 23 of the mobile terminal 21 is confirmed by using the camera unit 303 of the counterpart mobile terminal 31 in the above embodiments, the cursor image can be confirmed without using the camera unit 303 in FIG. 6.

FIG. 6 illustrates a process of recognizing a location using the mobile projector according to the embodiment of the present invention. In FIG. 6, it is assumed that the mobile terminal 21 and the counterpart mobile terminal 31 are in communication with each other.

Referring to FIG. 6, in order to set a relative location and an initial angle between the initial mobile terminal 21 and the counterpart mobile terminal 31, the second picture 33 is projected through the projector module 301 of the counterpart mobile terminal 31 and the first picture 23 is projected through the projector module 209 of the mobile terminal 21. The first picture 23 and the second picture 33 are projected while overlapping each other. In order to confirm the overlapped state, the first picture 23 may be projected onto a specific region of the second picture 33 including the cursor image. An angle between the two mobile terminals 21 and 31 is calculated based on a projection surface using the sensor units of the two mobile terminals 21 and 31 and is set to an initial angle ω.

The initial angle ω is set in this manner, even if one of the two mobile terminals 21 and 31 is moved, and a current angle between the two mobile terminals 21 and 31 can be confirmed and a relative location between the first picture 23 and the second picture 33 can be recognized using the current angle.

That is, when an initial angle ω, is set between the two mobile terminals 21 and 31 and the first picture 23 of the mobile terminal 21 is moved in an arbitrary direction, the initial angle ω is changed, and the degree by and direction in which the first picture 23 is moved can be determined by comparing a current angle and the initial angle ω. Thus, if an angle between the two mobile terminals 21 and 31 is accurately calculated, FIGS. 4 and 5 can be realized without the camera units 209 and 303.

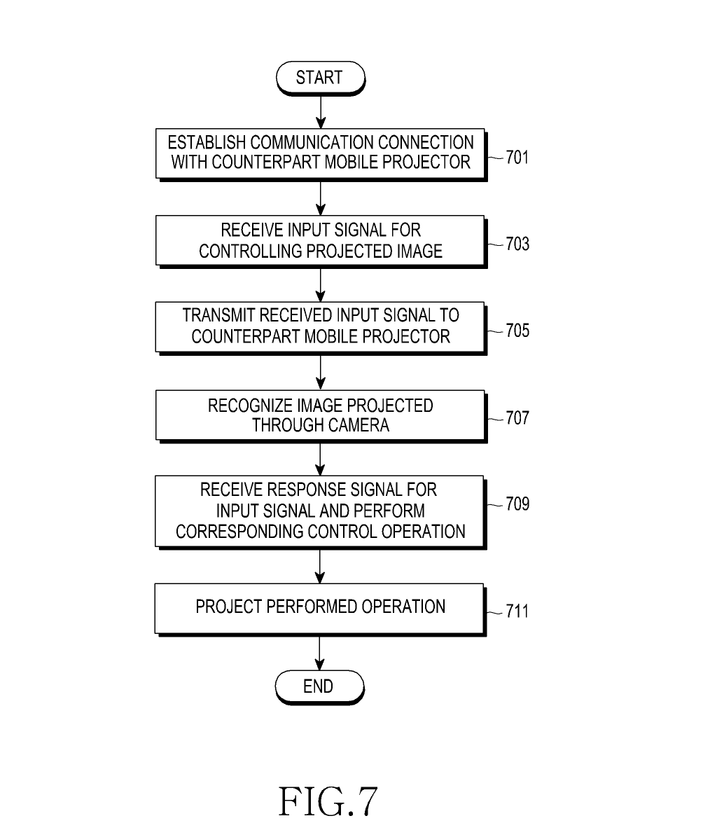

FIG. 7 illustrates a process of controlling an image using the mobile projector according to the embodiment of the present invention.

Referring to FIG. 7, in step 701, a mobile terminal establishes a communication connection with a counterpart mobile terminal to which the mobile terminal projects a photo image. A communication between the mobile terminal and the counterpart mobile terminal is performed, and the mobile terminal receives an input signal for controlling a photo image in step 703. In this process, the mobile terminal projects a first picture to a photo image included in a second picture of the counterpart mobile terminal, and when an input signal is received through the user input, the method proceeds to step 705 to transmit an input signal to the counterpart mobile terminal. For example, when an input/output unit is touched or a specific button is pushed after a user projects a cursor image included in the first picture and a specific region of the first picture so that they overlap a photo image to enlarge the photo image, the mobile terminal transmits an input signal for enlarging the photo image to the counterpart mobile terminal.

When receiving an input signal in step 707, the counterpart mobile terminal recognizes a location of a cursor image included in the first picture or a specific region of the first picture projected by the mobile terminal by using the camera unit mounted to the counterpart mobile terminal. When the cursor image in the first picture or the specific region of the first picture is projected onto the photo image, the counterpart mobile terminal generates a response signal for an input signal and transmits the response signal to the mobile terminal to perform a corresponding operation in step 709 and projects the corresponding operation in step 711.

For example, when an input signal for enlarging a photo image is received, the counterpart mobile terminal determines whether the cursor image included in the first picture of the mobile terminal or the specific region of the first picture is projected onto the photo image included in the second picture projected by the counterpart mobile terminal, using the cameral unit, and transmits a response signal for the received input signal to the mobile terminal if the cursor image or the specific region is projected and enlarges and projects the photo image.

Although FIG. 7 describes a process of recognizing the cursor image of the first picture or the specific region through the camera unit, an initial angle between the mobile terminal and the counterpart mobile terminal can be calculated without using the camera unit, and the process of FIG. 7 may be performed by determining a location of the projected cursor image according to changing angles while the mobile terminal or the counterpart mobile terminal are in motion.

According to the present invention, a mobile terminal communicates with a counterpart mobile terminal including a mobile projector to easily control a photo image projected through the counterpart mobile terminal using the mobile terminal.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. An image control apparatus using a mobile projector, the image control apparatus comprising:
a projector module configured to project a first picture to a projection surface;
a wireless network module configured to communicate with a counterpart apparatus projecting a second picture; and
a control unit configured to determine, when a user input for a specific image included in the second picture projected by the counterpart apparatus is received, whether the projected first picture is projected onto the specific image included in the second picture, and if the first picture is projected onto the specific image, control the counterpart apparatus to perform an operation corresponding to the user input by the specific image.

2. The image control apparatus as claimed in claim 1, further comprising:
an input/output unit configured to output the first picture and receive a user input;
a sensor unit configured to calculate, when a movement of the apparatus is detected, a movement distance and a direction of the apparatus; and
a camera unit configured to recognize at least one of the projected first picture and second picture.

3. The image control apparatus as claimed in claim 1, wherein the first picture includes a cursor image and is projected while overlapping a specific image included in the second picture to perform an operation corresponding to the user input.

4. The image control apparatus as claimed in claim 3, wherein the counterpart apparatus determines whether the cursor image is projected while overlapping the specific image through a camera unit mounted to the counter apparatus and transmits a determination result to the apparatus.

5. The image control apparatus as claimed in claim 1, wherein when the first picture is projected onto the specific image of the second picture while overlapping the second picture, the sensor unit calculates an initial angle between the apparatus and the counter apparatus with respect to the projection surface.

6. The image control apparatus as claimed in claim 5, wherein the control unit calculates an angle change resulting from a movement of the apparatus or the counterpart apparatus based on the calculated initial angle to determine current locations of the first picture and the second picture.

7. The image control apparatus as claimed in claim 1, wherein when the first picture is projected onto the specific image of the second picture while overlapping the second picture, a size of the photo image is changed to be projected if the input/output unit is touched or clicked.

8. The image control apparatus as claimed in claim 1, wherein when the first picture is projected into the specific image of the second picture while overlapping the second picture, and the first picture is moved out of a region of the second picture with the input/output unit being touched or clicked, the specific image is copied to the apparatus and is projected onto the first picture.

9. A method for controlling an image using a mobile projector, the method comprising:
establishing a communication connection with a counterpart apparatus projecting a second picture;
projecting a first picture onto a projection surface;
receiving a user input for a specific image included in the second picture projected by the counterpart apparatus;
determining whether the first picture is projected onto a specific image included in the second picture; and
controlling, when the first screen is projected onto the specific image, the counterpart apparatus to perform an operation corresponding to the user input by the specific image.

10. The method as claimed in claim 9, further comprising:
calculating, when a movement of an apparatus projecting the first picture is detected, a resulting value for a movement distance and a direction of the apparatus.

11. The method as claimed in claim 9, wherein the first picture includes a cursor image and is projected while overlapping a specific image included in the second picture to perform an operation corresponding to the user input.

12. The method as claimed in claim 11, wherein the counterpart apparatus determines whether the cursor image is projected while overlapping the specific image through a camera unit mounted to the counter apparatus and transmits a determination result to the apparatus projecting the first picture.

13. The method as claimed in claim 9, wherein when the first picture is projected onto the specific image of the second picture while overlapping the second picture, the sensor unit calculates an initial angle between the apparatus projecting the first picture and the counter apparatus with respect to the projection surface.

14. The method as claimed in claim 13, wherein the control unit calculates an angle change resulting from movement of the apparatus or the counterpart apparatus based on the calculated initial angle to determine current locations of the cursor image and the photo image.

15. The method as claimed in claim 9, wherein when the first picture is projected onto the specific image of the second screen while overlapping the second picture, and a touch screen of the apparatus projecting the first picture is touched or a specific button is clicked, a size of the specific image is changed to be projected.

16. The method as claimed in claim 9, wherein when the first picture is projected onto the specific image of the second screen while overlapping the second picture, and the first picture is moved out of a region of the second picture with the touch screen of the apparatus projecting the first picture being touched or a specific button being clicked, the specific image is copied to the apparatus or projected onto the first picture.

17. An image control system using a mobile projector, comprising:
a first apparatus configured to determine, when a first picture is projected and a user input for a specific image is received, whether the projected first picture is projected onto the specific image, and when the first picture is projected onto the specific image, control the specific image to perform an operation corresponding to the user input; and
a second apparatus configured to, when the specific image is projected, receive the user input from the first apparatus, determine whether the first picture is projected onto the specific image, and when the first picture is projected onto the specific photo image, perform an operation corresponding to the user input.

18. The image control system as claimed in claim 17, wherein the second apparatus determines whether the first picture is projected onto the specific image by using a camera unit mounted to the second apparatus.

19. The image control system as claimed in claim 17, wherein the first picture includes a cursor image which is projected onto the specific image while overlapping the specific image.
